(19) United States
(12) Patent Application Publication
(10) Pub. No.: US 2015/0008287 A1
(43) Pub. Date: Jan. 8, 2015

(54) Spacecraft's parachutes with straps for compensating the oscillations

(71) Applicant: Pavlos Dem. Giannakopoulos, Patra (GR)

(72) Inventor: Pavlos Dem. Giannakopoulos, Patra (GR)

(21) Appl. No.: 14/120,631

(22) Filed: Jun. 11, 2014

(30) Foreign Application Priority Data
Jun. 11, 2013 (GR) 20130100628

(51) Int. Cl. B64G 1/62; B64D 17/80; B64G 1/52; B64D 17/24

(52) U.S. Cl. CPC B64G 1/62; B64D 17/24; B64D 17/80; B64G 1/52
USPC 244/139

(57) ABSTRACT

Spacecraft's (40) parachutes (50) equipped with additional small compensating oscillations straps (45, 46), that are installed on the spacecraft (40) and are used especially during the activation and the operation of the parachutes (50) during the return with entrance into the Earth's atmosphere, with aim to pause the spacecraft's oscillations (40) for a safe splashdown.

### FIELD OF THE ART

The invention is about the field of the art of spacecraft's parachutes in which equipment have been added two or more small straps for compensating oscillations, which are caused when the spacecraft accesses the atmosphere for the splashdown and the compensating straps are attached with their lower extremes in suitable strong places on the floor of the department in the front place of the spacecraft and especially opposite of the lower extremes of the other small straps which already exist connected in suitable strong points on the floor below the cover of the top and they hold in alone via straps of the main parachutes, the main weight of the spacecraft. The compensating straps with their other upper extremes, along with the other upper extremes of the small straps which are already existing, they all connect on the confluence spot (Confluence Fitting) together with the “feet” (bottoms) of all the major straps.

All the above and other features, without leaving the area of the invention could be applied on the spacecraft from the begging of the landing phases such as during the opening of the drogue parachutes.

The additional small straps of the invention are compensating the unexpected trends of height—depth and direction which are shown from the various loads of the spacecraft and with the contrary trend which is produced from these small countervailing straps the trend of oscillations from the loads of the spacecraft about the confluence spot (Confluence fitting) of all the drogue straps and the main parachutes comes back to zero.

The new additional countervailing straps stretch, but with durability so without holding the weight of the spacecraft at the opening of the drogue and main parachutes they significantly reduce horizontal, vertical transport movements and the transverse translational motion called sideslip contributing this way to a soft landing while the other opposite straps, which are already existing, undertake holding the weight of the spacecraft.

In the previous technique the original recommendation is that the landings of the spacecrafts with parachutes will be performed in water and the splashdown is set as the initial operation. The “feet” (bottoms) of the existing small straps that hold the weight of the spacecraft are connected only to the one side of the top and especially to the floor of the department in the front place of the top so that the splashdown—impact of the spacecraft will be performed angled inclined of the one side and so small surface impact to the water.

Because the Confluence Fitting of the main parachute's straps is connected only to the one side of the top of the spacecraft, the main parachutes suddenly activated by the weight of the spacecraft cause at first the deceleration of it, but also oscillations of the spacecraft are caused by the wind, while loads of significant stroke can be transmitted to astronauts through the intervening connections of the spacecraft such as the floor and the seat.

If these loads are not attenuated at sustainable levels, they could have lead to serious injuries or even death of the people on board. Simple structures of the seat are not enough to protect the passenger from abnormal oscillations during the landing and consequently the further protective techniques must be looked into. In the previous technique, despite the significant improvement in the production of parachutes for equipment of the spacecraft, the spacecraft's oscillations during the return to Earth is still a problem even today and the research has identified the excessive abnormal oscillations with the speed of descent as the key factor for injuries within the spacecraft.

In fact, the rates of the descent and the resultant force have increased mainly because the spacecrafts would carry heavier loads in relation with the equipment. The added weight means that the spacecraft descends with a higher speed and with significantly greater power which makes the crew more prone to injuries.

The round dome of the parachute which is used by the spacecraft has been in operation for almost many years without great changes, while many efforts have been made in recent years to blunt problems with the landing speed for both the crew and the systems for the loads of the spacecraft. However, the design of the parachute-spacecraft must meet the safety requirements for the crew for damping spaceship's oscillations.

It is therefore a first primary subject of the present invention to provide compensating oscillations straps of the unexpected moments, which are presented by the various loads during the spacecraft's deceleration from the parachutes in the atmosphere and, the straps offer the ability to manage the energy that occurs as a result of the sudden applied force on them and they significantly reduce the energy and the speed of the spacecraft's oscillations and they offer stability and ability to the spacecraft to return to its original equilibrium after disturbances that come from the deceleration and uniformities of the atmosphere but also from many other causes so that adverse effects on the crew would be minimized.

The elements of the compensating straps height-depth and direction of the spacecraft manage to compensate the unexpected moments that appear by the various loads at the deceleration of the spacecraft and the implementation of the invention's subject would be achieved. The material data of compensating straps could be made apart from that of polymers straps and from any other suitable material of flexible wire or stainless steel wire or other suitable material.

It is therefore another primary subject of the present invention to provide to the equipment of the main parachutes for the spacecraft's landing the compensating oscillations straps which are a different type and are adjusted to tolerate without holding the weight of the spacecraft and they remain stable so that they would not change the angle of the spacecraft so that the impact on the water would be performed on a small surface.

All the above and other features of the invention including various new details of construction will be described more particularly with reference to the accompanying drawings, description, and pointed out in the claims.

It will be understood that the specific set that is embodying the invention is presented in a way of illustration only and not as a limitation for the invention. The principles and the features of this invention could be used in various embodiments without exiting from the scope of the invention.

### BRIEF DESCRIPTION OF THE DRAWINGS

With reference to the accompanying drawings, we will indicative describe preferred embodiments of the invention.

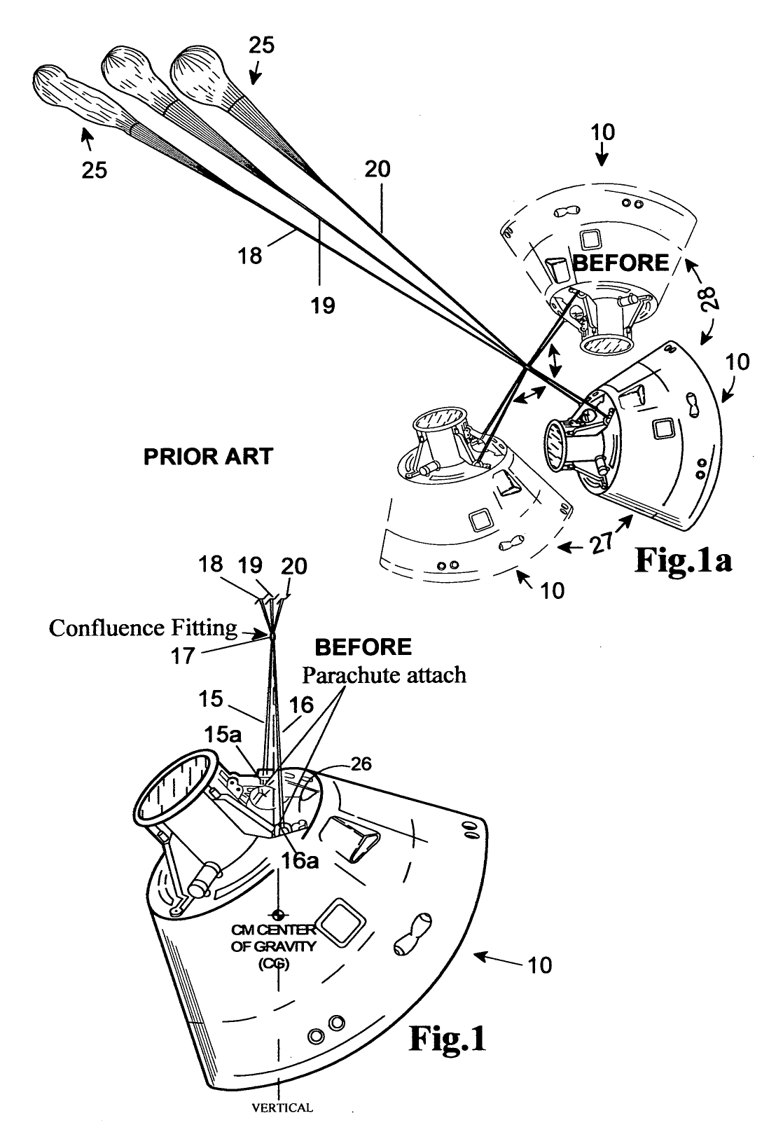

The FIGS. 1, 1a) present a perspective view of the spacecraft of the previous technology with straps retaining from the parachutes.

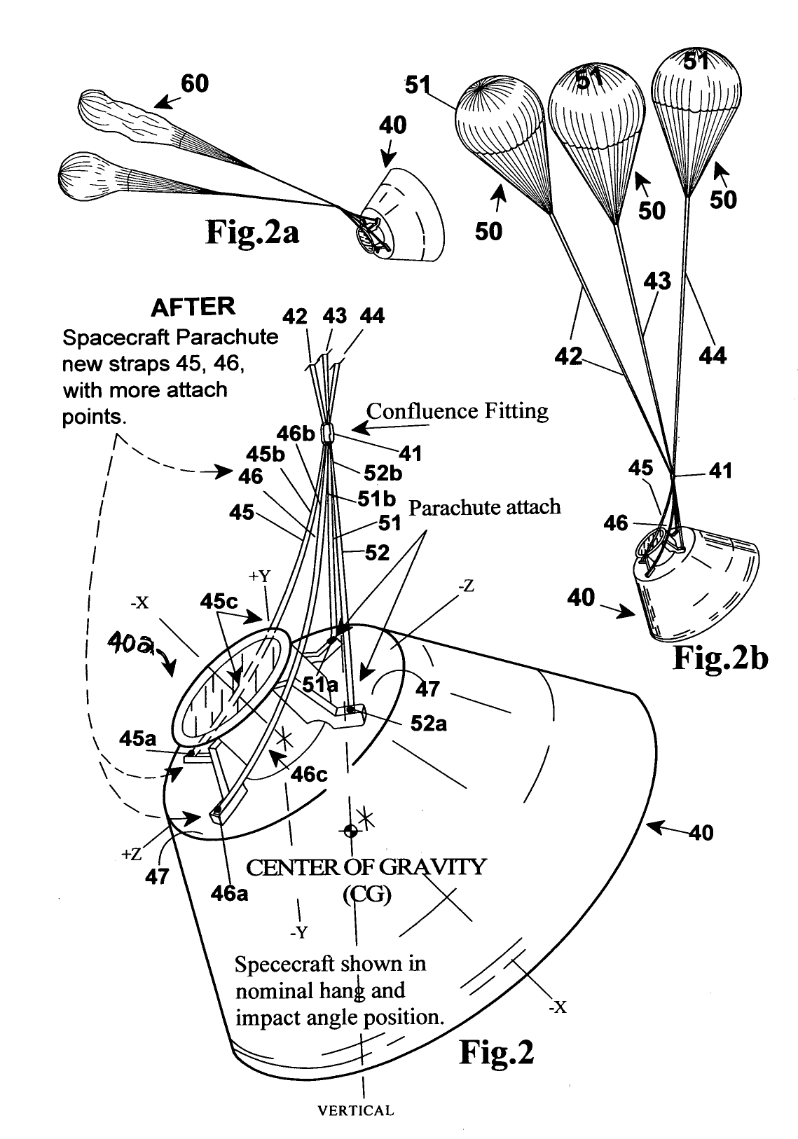

The FIGS. 2, 2a, 2b) present a perspective view of the spacecraft according to a preferred embodiment of the invention as available with the connection of the finished independent product with connection to a suitable spot on the main elevation straps of parachutes.

### DETAILED DESCRIPTION OF PREFERRED EMBODIMENTS

Now referring to the accompanying drawings, we will describe indicative, preferred embodiments of the invention. In the prior art the FIGS. 1, 1a) present with a perspective view the spacecraft (10) with the small retaining straps (15, 16) from the parachutes (25). The feet of the existing small straps (15, 16) that hold the weight of the spacecraft (10) are connected with their lower ends (15a, 16a) at appropriate points on the floor (26) of the department under the cover of the top on the front place of the spacecraft (10) only to the one side of the spacecraft (10) so that the impact of the spacecrafts would be performed at an angle, with slope, and small impact area on the water.

Because the point of confluence (Confluence fitting) (17), of the large straps (18, 19, 20) of the main parachutes (25) is connected only to the one side of the spacecraft's top (10) the main parachutes (25) are suddenly activated by the spacecraft's weight (10) cause a deceleration but at the same time spacecraft's oscillations are caused both horizontally (27) and vertically (28), but oscillations can also be caused by the wind, while significant loads could be transmitted to the astronauts through the vehicle's interfaces (10) that touch such as the floor and the seats.

According to the preferred embodiment of the invention the FIGS. (2, 2b) present at a perspective view the spacecraft (40) as supplied with its connection as a final product, connected to a suitable point of the confluence (Confluence Fitting) (41), of the long straps (42, 43, 44) of the main parachutes (50), which have been added to the equipment the two at least additional small straps (45, 46) that compensating the oscillations of the spacecraft (40) that operate during the opening of the canopies (51), of the main parachutes (50).

The preferred embodiment of the present invention is presented with a perspective view in FIGS. 2, 2b) with the compensating oscillations small straps (45, 46) being connected strongly with their lower ends (45a, 46a) at appropriate points in the strong base of the floor (47) to the department under the top's cover on the front place (40a) of the spacecraft (40) and, with the other upper ends (45b, 46b) the small straps (45, 46) are strongly connected on the confluence point (Confluence fitting) (41), of the long straps (42, 43, 44) in the legs of the main parachutes (50) together with the other upper ends (51b, 52b) of the small straps (51, 52), which already exist and are strongly connected to the one side of the top and they hold the weight of the spacecraft (40) and, with their lower ends (51a, 52a) are strongly connected at appropriate points on the strong floor base (47) of the department under the top's cover to the front of the spacecraft (40).

The two (2) additional small straps (45, 46) for compensating oscillations of the spacecraft (40) in order that the impact of the spacecraft (40) will always be performed at an angle, with slope, and small impact area on the water, stretch, but with tolerance and they do not hold the weight of the spacecraft (40) during the opening of the canopies (51), of the main parachutes (50) and are connected to the floor base (47) opposite of the small straps (51, 52) that already exist and they hold the weight of the spacecraft (40) so that the impact of the spacecraft will always be performed at an angle, with slope, and small impact surface on the water.

The two (2) additional small straps (45, 46) for compensating oscillations of spacecraft (40) are longer in comparison with other existing small straps (51, 52) that already exist and they hold the weight of the spacecraft (40). This length of the small straps (45, 46) is as much as is needed to always keep from the beginning the predetermined angle, with slope, of the spacecraft (40) for the impact to the water.

All the above and other features of the compensating oscillations small straps (45, 46) of the invention, without leaving from the scope of the invention may be applied with small additional straps on the spacecraft (40) from the beginning of the landing phase such as the opening of the (Drogue Parachutes) (60), FIG. 2a).

The additional small straps (45, 46) of the invention, operating by compensating the unexpected torques of height-depth and direction that are presented by the various loads of the spacecraft (40), and the reverse torque that is generated by this small countervailing straps (45, 46), FIGS. 2, 2b). The total toque to the confluence point (confluence fitting) (41), of the spacecraft (40) returns to zero.

The additional new countervailing straps (45, 46) stretch, but with tolerance, without holding the weight of the spacecraft (40), during the opening of the drogue parachutes (60) and the main parachutes (50) and they significantly reduce the horizontal, vertical and transport movements and, the lateral translational motion that is called sideslip FIGS. 2, 2a, 2b) which are presented by the various loads of the spacecraft (40), contributing that way to a soft landing while the other opposite straps (51, 52) that already exist undertake the holding of the spacecraft's weight.

The small compensating oscillations of height—depth and direction straps (45, 46) stretch with tolerance and as it is distinguished in a perspective view in FIGS. 2, 2a, 2b) the small straps (45, 46) during the activation of the main parachutes (50) are forming every one of them a small curve, “belly” (45c, 46c), obviously that they remain under tolerance and they do not hold the weight of the spacecraft (40) during the opening of the canopies (51), of the main parachutes (50).

The small compensating oscillations straps (45, 46) have length as much as is needed in order to remain always from the beginning the angle, with the gradient, predetermined of the spacecraft (40), for the impact on the water.

The small compensating oscillations straps (45, 46) have always a length greater than the length which are having the opposite straps (51, 52).

The small straps (51, 52) that hold the weight of the spacecraft (40), always have a length shorter than the length that the opposite small compensating oscillations straps are having (45, 46), so that the spacecraft (40) during the opening of the canopies (51), of the parachutes (50), would always be at an angle, with gradient, and small impact area on the water.

It should be noted here that the description of the invention had been made with reference to illustrative examples of the application which are not limited to. Thus, any change or modification with respect to the described figures, sizes, provisions, materials and manufacturing components and assembly parts, techniques applied in the construction and operation of the elements of the invention, as long as there is not new inventive step and do not contribute to the technical development of the already known, is considered that is included at the purposes and the aspirations of the present invention, as are specified at the claims below:

1. As it has been said above spacecraft's (40) parachutes (50) with additional equipment of small straps (45, 46) for compensating oscillations where the straps (45, 46) consist of these used polymers-polyester materials with planar array, where the lower ends of them (45a, 46a) of the termination of the small straps (45,46) remain firmly connected at a first constant anchor point to the said floor (47) of the said compartment beneath the top's cover at the front part (40a) of the spacecraft (40), and the said upper ends (45b, 46c) remain firmly connected to a second constant anchor and confluence point (41) (Confluence Fitting) along with the “feet” of the termination of the major straps (42, 43, 44) of the said main parachutes (50), and the said small straps (45, 46) are connected with the said lower ends (45a, 46a) on the floor (47) and opposite from the lower extremes of the termination (51a, 52a) remain firmly connected to a first constant anchor point to the floor (47) and the said upper ends of the termination (51b, 52b) of the small straps (51, 52), remain firmly connected to a second constant anchor and confluence point (41) (Confluence Fitting), along with the termination of the feet of the major straps (42, 43, 44) of the main parachutes (50), and the upper ends (51b, 52b), remain firmly connected together with the upper ends (45b, 46b) of the small straps (45, 46) of termination, where the small straps (45,46) have been characterized by that:
Installed on the spacecraft (40) with a connection of safety means of parachutes (50) and especially used during the activation and operation of parachutes (50) during the entrance to the Earth's atmosphere and have the ability of managing the energy which occurs as a result of the attenuation forces of straps (45, 46) of the existing tension with the ability to compensate the unexpected torques that are presented by the loads and the power transfer tensile from the first constant anchor point (47) of the lower ends (45a, 46a) of the termination of small straps (45,46) to the second constant anchor and confluence point (41) (Confluence Fitting), with aim to pause the oscillations of height—depth and direction (27, 28) from the start of the entrance in the Earth's atmosphere of the spacecraft (40), for a safe splashdown and where:
the said small straps (45, 46) receive the energy in the form of traction exerted on the said first constant anchor point to the floor (47) in the front part (40a) of the said spacecraft (40), and channel this energy in this form of traction to the said second constant anchor and confluence point (41) (Confluence Fitting), at the termination of feet of the major straps (42, 43, 44) of the main parachutes (50), of the spacecraft (40), doing that way, it is effecting the required during the entrance into the atmosphere for landing, of the work of proper delimitation of the energy's management which occurs as a result of the applied force on them and thus the pause of the oscillations of height—depth and direction (27, 28).

2. Spacecraft's (40) parachutes (50) with additional equipment of small straps (45, 46) for compensating the oscillations according to the claim 1, are characterized by that they are destined for the proper delimitation of the said spacecraft (40) during his return and is during the entrance into the Earth's atmosphere through the tensioning of the straps (45, 46) and stopping these said oscillations of height—depth and direction (27, 28) where:
As it has been said the small straps (45, 46) for compensating the oscillations of height-depth and direction (27, 28) stretching with tolerance (45c, 46c) and together with the said large straps (42, 43, 44) do not hold the weight of the spacecraft (40) at the opening of the canopies (51) of the main parachutes (50).
As it has been said the small straps (45, 46) have length as much as is needed to keep always from the beginning the angle predetermined, with the gradient, of the spacecraft (40) for the impact to the water.
As it has been said the small straps (45, 46) always have length greater than the length that the opposite said straps have. (51, 52) As it has been said he small straps (45, 46) consist of these used polymers-polyester materials with planar array, or stainless steel wire or other suitable material.
The small straps (51, 52) that already exist always have length less than the length that the opposite said straps have (45, 46) and, are characterized by that are destined for the proper delimitation of safety things and alone they hold together with the long straps (42, 43, 44) the weight of the said spacecraft (40) so that during the opening of the said canopies (51) of the said parachutes (50) of the said spacecraft (40) would always be at an angle, with a gradient, for a small impact surface on the water.

3. Spacecraft's (40) parachutes (60) with additional equipment of two or more of the said small straps (45, 46) for compensating the oscillations of height-depth and direction (27, 28) are presented by the various loads of the said spacecraft (40) upon its return and during the entrance into the Earth's atmosphere by the drogue parachutes (60) and, characterized by that they are destined for the proper delimitation of safety things with the opposing torque that is generated by this small (45, 46) countervailing straps, and the total torque from the said first constant anchor point (47) relative to the said second constant anchor and confluence point (41) (Confluence Fitting), of the spacecraft (40) returns to zero.
